(19) United States
(12) Patent Application Publication
(10) Pub. No.: US 2023/0186689 A1
(43) Pub. Date: Jun. 15, 2023

(54) METHODS AND MECHANISMS FOR CROWD HEALTH MONITORING CHARGING PORT FUNCTIONALITY

(71) Applicant: GM GLOBAL TECHNOLOGY OPERATIONS LLC, Detroit, MI (US)

(72) Inventors: Seyedmohammad Hosseini, Thornhill (CA); Milad Jalaliyazdi, Richmond Hill (CA); Hamed Kazemi, Scarborough (CA)

(73) Assignee: GM GLOBAL TECHNOLOGY OPERATIONS LLC, Detroit, MI (US)

(21) Appl. No.: 17/550,183

(22) Filed: Dec. 14, 2021

(51) Int. Cl. G07C 5/00; H02J 7/00; G07C 5/08; B60L 3/04; G06T 7/00

(52) U.S. Cl. CPC G07C 5/006; H02J 7/00712; G07C 5/0808; B60L 3/04; G06T 7/0002; G06T 2207/30248

(57) ABSTRACT

A non-transitory computer-readable medium and methods capable of being executed thereby are provided. The non-transitory computer-readable medium includes contents that are configured to cause a computing system to perform the method related to a charging port of an electrified vehicle. The method, or methods, include taking a current photo of at least one of a charging receptacle or a cordset of the charging port; image processing the current photo; and determining whether the current photo includes one or more identified faults from the image processed current photo. If one or more identified faults are present in the image processed current photo, at least one of: sending a maintenance message; limiting charging; or adjusting system parameters.

### INTRODUCTION

The present disclosure relates to methods and mechanisms for determining the functionality, or assessing the health, of vehicles having electric charging capabilities, such as plug-in hybrid and electric vehicles, and charging ports associated therewith.

### SUMMARY

A non-transitory computer-readable medium and methods capable of being executed thereby are provided. The non-transitory computer-readable medium includes contents that are configured to cause a computing system to perform the method related to a charging port of an electrified vehicle. The method, or methods, include taking a current photo of at least one of a charging receptacle or a cordset of the charging port; image processing the current photo; and determining whether the current photo includes one or more identified faults from the image processed current photo. If one or more identified faults are present in the image processed current photo, sending a maintenance message.

Additional features may include: the image processing occurs in a cloud network, remote from the electrified vehicle. Creating a severity index based on the identified faults; comparing the severity index to a threshold index level; and if the severity index exceeds the threshold index level, one of preventing/disabling a charging event or limiting the charging event. The cloud network may include a plurality of previous photos and a baseline charging port health may be established based on the previous photos. The methods may compare the current photo to one or more of the previous photos of the electrified vehicle and determine whether the current photo includes identified faults from the comparison between the current photo and the to one or more of the previous photos.

The methods may include mating a cordset of a charging station to a charging receptacle of the electrified vehicle, and counting a number of latch attempts to successfully latch the cordset to the charging receptacle. Then, comparing the number of latch attempts to an expected receptacle baseline for the charging receptacle, and, if the number of latch attempts exceeds the expected receptacle baseline, flagging the cordset of the charging station through a cloud network. Similarly, the methods may include comparing the number of latch attempts to an expected cordset baseline for the cordset for the charging receptacle, and, if the number of latch attempts exceeds the expected cordset baseline, flagging the charging receptacle of the electrified vehicle through the cloud network.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a vehicle having one or more rechargeable energy storage systems (RESS) in electrical communication with at least one charging receptacle.

FIG. 2A is a schematic graph of a charging current applied through the charging receptacle.

FIG. 2B is a schematic graph of temperature measurements of pin within the charging receptacle while subject to the schematic charging current of FIG. 2A.

FIG. 3 is a schematic diagram of a flow chart for determining health of the charging receptacle.

FIG. 4 is a schematic diagram of a charging receptacle having one or more faulted pins or areas.

FIG. 5 is a schematic diagram of a cordset selectively insertable to a charging receptacle.

### DETAILED DESCRIPTION

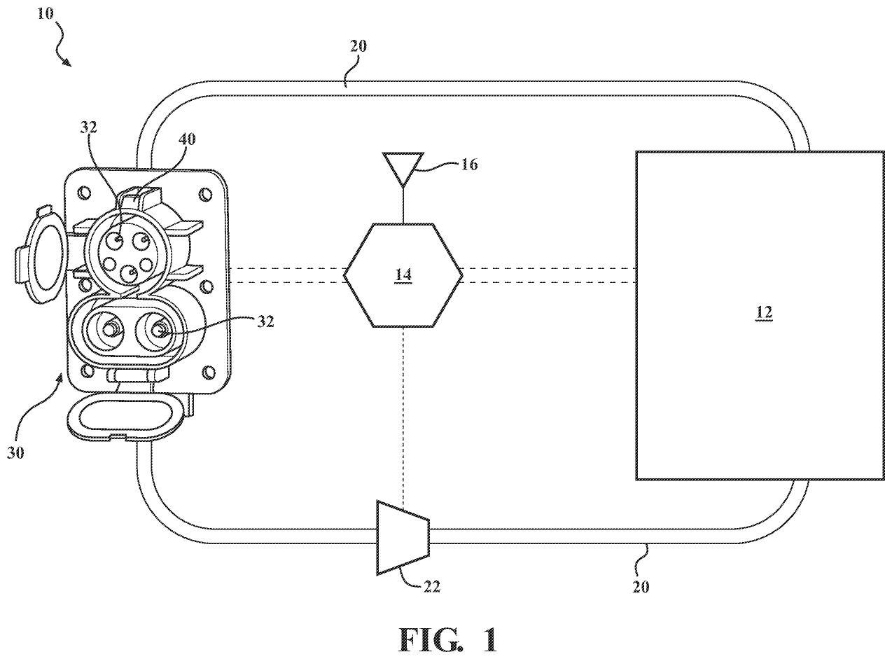

Referring to the drawings, like reference numbers refer to similar components, wherever possible. All figure descriptions simultaneously refer to all other figures. FIG. 1 schematically illustrates a portion of a vehicle 10, shown highly schematically, which may be, for example and without limitation, an electric vehicle or a hybrid-electric vehicle, such that the vehicle 10 may be referred to as an electrified vehicle 10. The vehicle 10 includes a rechargeable energy storage system (RESS) 12, which may include, for example and without limitation, a rechargeable battery or rechargeable battery pack.

A control system or controller 14 is operatively in communication with necessary components of the vehicle 10 in order to execute the methods, algorithms, and health assessments described herein. The controller 14 includes, for example and without limitation, a non-generalized, electronic control device having a preprogrammed digital computer or processor, a memory or non-transitory computer readable medium used to store data such as control logic, instructions, lookup tables, etc., and a plurality of input/output peripherals, ports, or communication protocols. The controller 14 is configured to execute or implement any and all control logic or instructions described herein.

Furthermore, the controller 14 may include, or be in communication with, a plurality of sensors, including, without limitation, those configured to sense or estimate ambient temperature outside of the vehicle 10, various coolant temperatures within the vehicle 10, and other sensing capabilities. The controller 14 may be dedicated to the specific aspects of the vehicle 10 described herein, or the controller 14 may be part of a larger control system that manages numerous functions of the vehicle 10.

The drawings and figures presented herein are diagrams, are not to scale, and are provided purely for descriptive and supportive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way. Any use of the term, “or,” whether in the specification or claims, is inclusive of any specific element referenced and, also, includes any combination of the elements referenced, unless otherwise explicitly stated.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

All numerical values of parameters (e.g., of quantities or conditions) in this specification, including the appended claims, are to be understood as being modified in all instances by the term about whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used, the term “substantially” refers to relationships that are ideally perfect or complete, but where manufacturing realties prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

The vehicle 10 includes a communications system 16 that is capable of sharing information determined by the controller 14, for example, or other parts of the vehicle 10 with locations outside of the vehicle 10. For example, and without limitation, the communications system 16 may include cellular or Wi-Fi technology that allows signals to be sent to centralized locations, such as cloud storage or communications networks.

A coolant circuit 20 or coolant system is in communications with the RESS 12 and includes at least one pump 22. If the vehicle 10 also includes an internal combustion engine, the coolant circuit 20 may also pass through the internal combustion engine, or there may be separate coolant systems for other components of the vehicle 10.

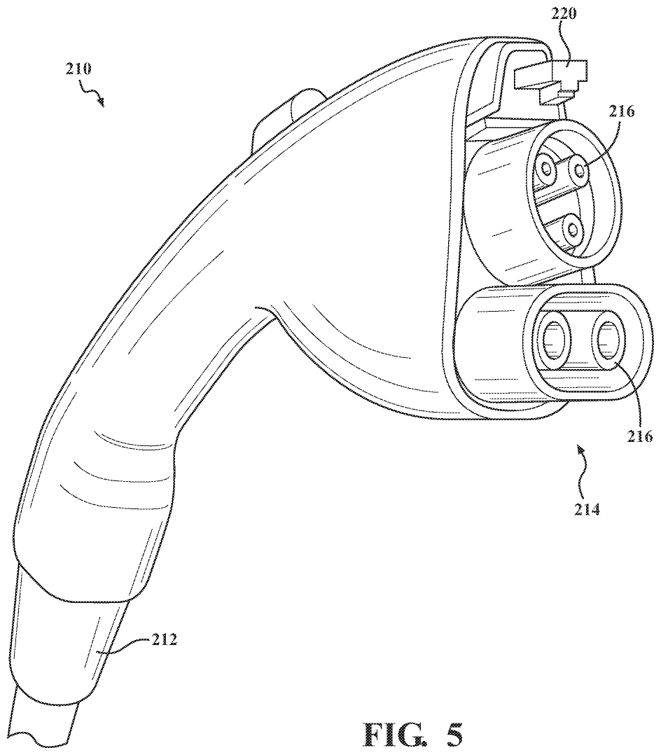

A charging receptacle 30 having a plurality of pins 32 is in communication with, at least, the controller 14 and the RESS 12. The charging receptacle 30 cooperates with a charging station, generally through a charging cable or cordset, which is not shown in FIG. 1 but is shown schematically in FIG. 5. The charging receptacle 30 and the cordset may collectively be referred to as a charging port. The charging cable may include some, or all, corresponding features to the pins 32. The charging receptacle 30 is also in communication with the coolant circuit 20.

The example charging receptacle 30 shown has a total of seven pins 32, some of which may not be viewable in the figures. The upper set (relative to FIG. 1) are for alternating current charging and the lower set (relative to FIG. 1) are for direct current charging. Note that not all of the pins 32 may be used for passing charging current, as some may be used for communication and/or controlling the charging current flowing from the charging station through the charging receptacle 30. In some configurations, several of the pins 32, or the holes in which pins are not illustrated, but may pins, may be used for communication and/or control of the charging process.

Additionally, note that different charging ports may be utilized with the methods and mechanisms described herein, including those with additional or fewer total pins. For example, and without limitation, nine pin or five pin receptacles may be utilized, and receptacles having only AC or only DC connectivity may be utilized.

Several temperature measurement devices are embedded within, or adjacent to, the charging receptacle 30, such that the temperature of one or more of the pins 32 may be monitored and communicated to the controller 14. For example, and without limitation, thermocouples may be disposed near some, or all, of the pins 32.

The charging receptacle 30 includes a locking mechanism or lock 40, which may cooperate with a corresponding locking mechanism on the charging cable. Note that not all charging stations or charging receptacles 30 will include the lock 40 or corresponding structure.

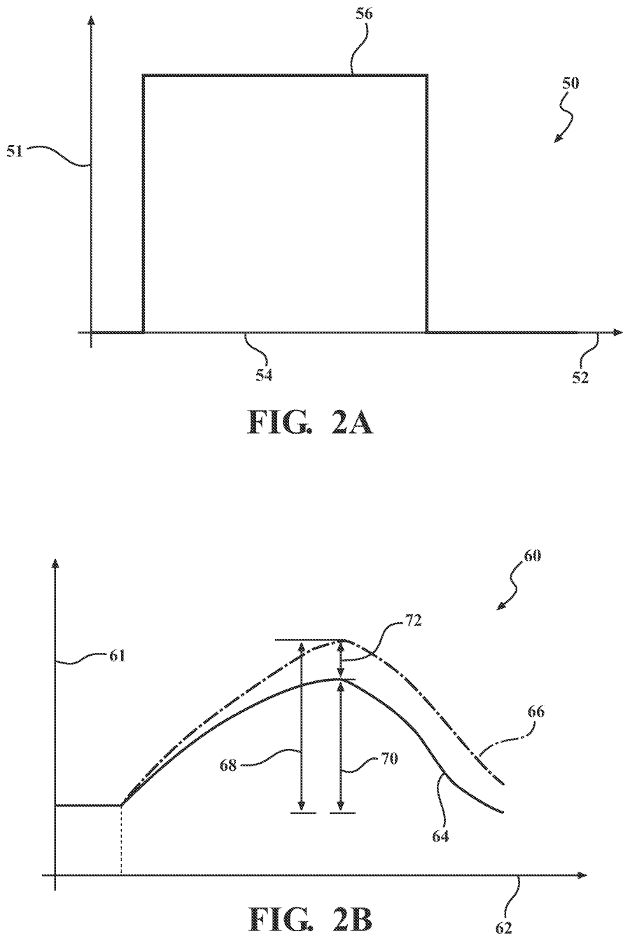

Referring now to FIG. 2A and FIG. 2B, and with reference to the other figures, there are shown schematic graphs illustrating mechanisms, methods, or algorithms for testing and/or detecting functionality of the charging receptacle 30. FIG. 2A shows a schematic current graph 50, with the y-axis showing current 51 and the x-axis showing time 52. The current graph 50 shows current flowing through the charging receptacle 30 while subject to a charging current.

As shown in FIG. 2A, a charging current, which may be referred to as a baseline charge current 54, is supplied through the pins 32. During this time, the vehicle 10 is subject to a charging cycle that is geared toward recharging the RESS 12. The controller 14 is also monitoring the pin temperature of the pins 32, at least while subject to the charging current. The controller 14, or another control system managing the charging cycle, applies a first step function 56 to the charging current. Note that the baseline charge current 54 may be either zero or non-zero. Where the baseline charge current 54 is zero, the health assessment described herein may occur before the charge cycle is started.

FIG. 2B shows a schematic temperature graph 60, with the y-axis showing temperature 61 and the x-axis showing time 62. The schematic temperature graph 60 illustrates an expected temperature 64, which may also be referred to as a normal temperature, and a measured temperature 66.

During the first step function 56, the controller 14 is monitoring a first step change 68 in pin temperature. This may be the difference between the temperature during the baseline charge current 54 and the temperature increase caused by the first step function 56.

The temperature increase may be caused by Joule heating, which may be considered the physical effect by which the passage of current through an electrical conductor produces thermal energy. As would be recognized by skilled artisans, imperfections or degradations in the pins 32 may result in greater Joule heating than would be expected in pins 32 that substantially lack such imperfections.

The controller 14 compares the first step change 68 in pin temperature to a first expected temperature change 70 to create a first deviation 72. This generally quantifies the amount excess, or unexpected, heat generated by the pins 32 during the first step function 56.

The controller 14 may then compare the first deviation 72 to a predetermined threshold. If the first deviation 72 exceeds the predetermined threshold, the controller 14 may then signal a maintenance alert, and if the first deviation 72 is less than the predetermined threshold, the controller 14 may log or store the first deviation 72. In some cases, logging the first deviation 72 may include sending the data to a cloud or network from storage offboard the vehicle 10. The thresholds may be specific to the type of vehicle 10 or may be general thresholds. Additionally, the thresholds may be updated, such as through the cloud network, during the operational lifetime of the vehicle 10.

Depending on the magnitude of the first deviation 72, the maintenance alert may include several possible actions or alerts. For example, and without limitation, the maintenance alert may include alerting the operator of the vehicle 10 that the operator should take the vehicle 10 for service, or, in some cases, stopping the charging cycle early to prevent further damage to the charging receptacle 30 or other portions of the vehicle 10.

Factors causing degradation of, or damage to, the pins 32, may include, without limitation: external forces bending the pins 32, particulates grinding the surface of the pins 32, or unintended exposure of the charging receptacle 30 or pins 32 to heat. Factors resulting in further degradation of the pins 32 during charging cycles may include, without limitation: corrosion, surface cracks, electric arcing, or surface plating wear.

Identifying faults, degradation, or imperfection in the pins 32, or other components of the vehicle 10, may provide benefits to the vehicle 10, particularly when there is early detection such that minor faults are identified prior to creating more significant problems. For example, and without limitation, benefits includes: preventing loss of propulsion or inability to charge the vehicle 10 and the RESS 12, reduced towing and alternative transportation cost, and reduced labor costs associated with fault isolation or substantial damage to the systems of the vehicle 10.

Note that, in addition to the first step function 56, the controller 14 may apply additional step functions to further test function of the charging receptacle 30 during the charging cycle. Therefore, the controller 14 may apply a second step function and compare a second step change in pin temperature to a second expected temperature change to create a second deviation. Similarly, the controller may compare the second deviation to the predetermined threshold and determine whether signaling the maintenance alert and/or logging the temperature deviation is warranted.

In many cases, the controller 14 will not try to test functionality of the charging receptacle 30 during every charging cycle. For example, and without limitation, utilizing the step current—or other testing mechanisms, such as those described herein—may delay completion of the charging event in order to analyze functionality. Therefore, it may be beneficial to schedule this health assessment analysis occasionally, such as, for example and without limitation, during extended charging cycles.

To determine during which of the charging cycles should test functionality of the system, the controller 14 may use the history of the vehicle 10 to better determine when an extended charging cycle is likely to occur. For example, and without limitation, the scheduling methods may analyze the GPS location and history of previous charging cycles to determine that the vehicle 10 is often charged for extended periods of time when at home, such as overnight, or when at a work location. Other factors may include, without limitation: time of day, ambient temperature, RESS 12 state of charge, battery power requested, time since last health assessment, and the type of charging station to which the vehicle 10 is connected.

The scheduler method or function attempts to ensure uninterrupted charging when the operator wants to quickly gain some mileage without any delay, such as during rapid charges while traveling, and plans the health monitoring for situation that the operator leaves the vehicle 10 to charge for a longer time. Skilled artisans will recognize the difference between short charging cycles and extended charging cycles. In one example, and without limitation, a predicted charging cycle lasting three hours or more may be considered an extended charging cycle; or when the vehicle 10 will remain connected to the charging station after RESS 12 is fully charged.

Both the first step function 56 and any subsequent step functions may be controlled by the scheduler. In some cases, the scheduler function may occur offboard of the vehicle, such as within a cloud network, and be communicated to the controller 14. Note that, even with the scheduler estimating length of charging cycles, the operator of the vehicle 10 may have an irregular stop, such that the controller 14 may abort health assessment of the charging systems.

In order to complete the health assessment of the charging receptacle and its pins 32, the controller 14 uses different mechanisms for calculating the first expected temperature change 70. For example, and without limitation, calculations may be based on a formula equating stored energy to the difference between outflow energy and inflow energy added to energy generation, which may include a physics-based thermal model.

Equation 1 shows the balanced physics-based equation.

Ėᵢₙ−Ėₒᵤₜ+Ė_{g}−Ėₛₜ (1)

In Equation 1: Ėᵢₙ is inflow thermal and mechanical energy transfer; Ėₒᵤₜ is outflow thermal and mechanical energy transfer, such as through the coolant circuit 20 or convective heat transfer to ambient air; Ė₉ is thermal energy generation, such as by Joule heating; and Ėₛₜ is stored thermal energy, which increases the temperature of the pins 32.

Equations 2-5 contain portions of Equation 1.

$$\begin{matrix}{\dot{E}}_{in} = 0 & ( 2 ) \\ {\dot{E}}_{g} = {I}^{2} R & ( 3 ) \\ \dot{{E}_{out} = {h}_{amb} {A}_{1} ( T - {T}_{amb} ) + {h}_{f} {A}_{2} ( T - {T}_{f} )} & ( 4 ) \\ {\dot{E}}_{st} = ρ Vc \frac{dT}{dt} & ( 5 )\end{matrix}$$

In Equations 2-5: R=electrical resistance; I=electrical current; h=convection heat transfer coefficient, where h_{amb} is for the ambient air and h_{f} is for fluid; T is the sensed temperature of the receptacle pins 32; T_{amb} is ambient air temperature; T_{f} is coolant fluid temperature; A₁ is surface area between the charging receptacle 30 and the ambient air; A₂ is surface area between the charging receptacle 30 and the coolant fluid; and ρVc is thermal capacitance. By plugging Equations 2-5 into Equation 1, we can form Equation 6.

$$- {hA}_{1} ( T - {T}_{∞} ) - {h}_{f} {A}_{2} ( T - {T}_{f} ) + {I}^{2} R = ρ Vc \frac{dT}{dt} \qquad ( 6 )$$

Re-arranging the Equation 6, and using lumped parameters of P₁, P₂, and P₃, we form Equation 7, where: P₁=ρVc; P₂=h_{amb}*A₁; and P₃=H_{f}*A₂.

$${P}_{1} \frac{dT}{dt} + {P}_{2} ( T - {T}_{∞} ) + {P}_{3} ( T - {T}_{f} ) - {I}^{2} R = 0 \qquad ( 7 )$$

From Equation 7, the controller 14, or a subsystem thereof, can determine the expected temperature 64, and calculate the first deviation 72 from the difference between the first step change 68 and the first expected temperature change 70. Equation 7 may also be useful for determining the effective resistance of one or more pins 32. Note that onboard calculations, may occur through, for example, and without limitation, modeling functions or lookup tables.

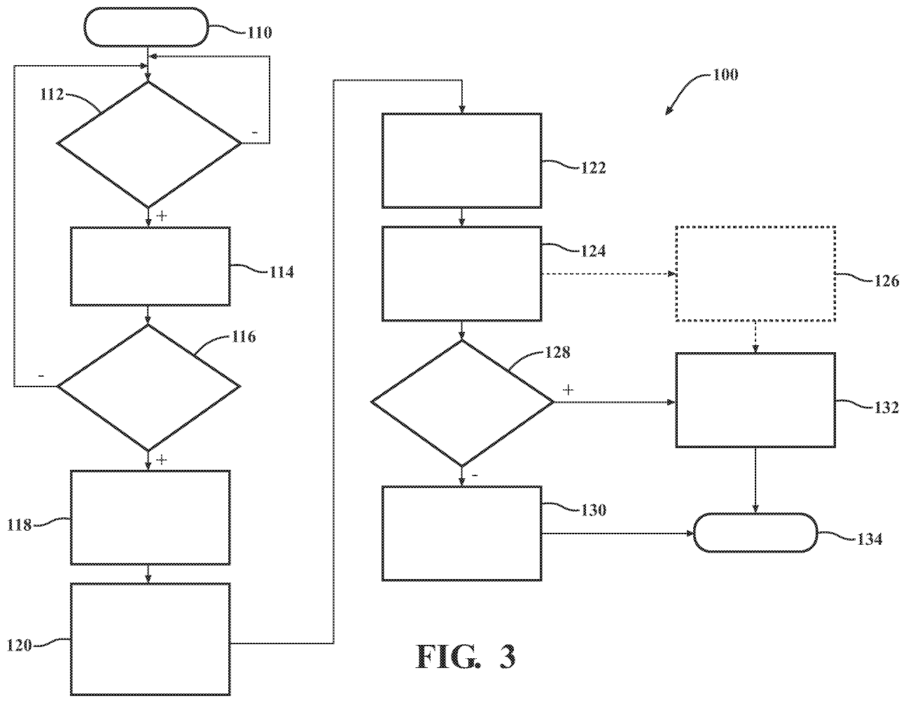

Referring now to FIG. 3, and with reference to all other figures, there is shown schematic flow chart illustrating mechanisms, methods, or algorithms for testing and/or detecting functionality of the charging receptacle 30. A method 100 is shown in FIG. 3 and illustrates one way of assessing the health of the charging receptacle 30, in addition to other portions of the vehicle 10, as described herein.

Step 110: Start/Initialize.

The method 100 may begin operation when called upon by the controller 14, may be constantly running, or may be looping iteratively.

Step 112: Connected to Station and Ready to Charge?

The method 100 determines whether the vehicle 10 is connected to a charging station and is ready to begin charging the RESS 12. If these conditions are not met, the method reverts to the start step 110, which may include iterating or pausing until before beginning again. Alternatively, the start step 110 may only initialize whenever the vehicle 10 is connected to the charging station and ready to charge.

Step 114: Health Assessment Scheduler.

The method 100 communicates with the scheduler, whether onboard the vehicle 10 or through a communications network. This helps determine whether the vehicle 10 should be tested.

Step 116: Enabling Conditions Met?

If the conditions of the health assessment scheduler are not met, the method reverts to the start step 110, which may include iterating or pausing until before beginning again. If the conditions are met, the method 100 proceeds to step 118.

Step 118: Monitor Temperature.

At this step, the method 100 monitors many temperature conditions, including, without limitation: ambient air, coolant fluid, and charging receptacle 30, which may include one or more of the individual pins 32. These conditions form the baseline during the initial charging phase.

Step 120: Apply Step Function and Monitor Temperature.

After establishing the baseline, the method 100 applies step conditions. The controller 14 may apply, for example, the first step function 56 to the charging current, as illustrated in FIG. 2A. The method 100 then monitors the changing temperature conditions in the charging receptacle 30 during, and likely after, the first step function 56, such as with one or more thermocouples effectively sensing the charging receptacle 30.

Step 122: Determine Expected Temperature and Resistance.

The method 100 determines the expected temperature, such as from the physics-based model and may also determine the resistance through the one or more pins 32 or the whole charging receptacle 30. The method 100 uses the expected temperature and the resistance in subsequent calculations and/or determinations.

Step 124: Estimate Deviation from Healthy Receptacle.

The method 100 estimates the deviation from a healthy—i.e., operating normally—charging receptacle 30. The method 100 may use a comparison between the expected temperature and the measured temperature to derive the deviation, such as the first deviation 72 illustrated in FIG. 2B. Alternatively, the method 100 may compare the calculated resistance to an expected resistance, based on the current and voltage conditions coming from the charging station.

Step 126: Determine Receptacle/Pin Health and Report (Optional).

The method 100 may include a step to determine the overall health of the charging receptacle 30 or individual pins 32. In turn, this health assessment may be logged or otherwise reported, such as to the cloud network. Determining the receptacle health, and reporting the health determination, may also be considered as an umbrella step encompassing steps 124-132. In many cases, summary reports may be sent to the operator of the vehicle 10 when the charging receptacle 30 is completely healthy.

Step 128: Predetermined Thresholds Exceeded?

The method 100 may compare the temperature deviation, resistance deviation, or both, calculated in step 120 to predetermined thresholds. As recognized by skilled artisans, these deviations may be vehicle specific based on, for example and without limitation, RESS 12 type and size, configuration of the charging receptacle 30, drivetrain type, and other system configurations.

Step 130: Continue Charging.

Where the determination in step 128 is negative—i.e., the answer is no, as represented by a “−” on the flow chart—the method 100 allows the vehicle 10 to continue charging. In such a situation, the method 100 may have determined that it is generally not detrimental to continue the charging cycle for the charging receptacle 30, the RESS 12, or other components of the vehicle 10.

Step 132: Generate Fault Message.

Where the determination in step 128 is positive—i.e., the answer is yes, as represented by a “+” on the flow chart—the method 100 generates a fault message. This may include, for example and without limitation: signaling the operator of the vehicle, such as through an onboard light, a messaging system, or a portable device app; and/or notifying a manager of the fleet, if the vehicle 10 is part of a fleet.

Furthermore, depending on the severity of the excursions over the threshold, step 132 may also include stopping the charging cycle. Particularly where the optional step 126 determines that the health of the charging receptacle 30 is greatly degraded, the method 100 may determine that it is best to shut down the charging cycle without much further delay. This would likely generate additional fault messages, including alerting service personnel, or repair personnel for the vehicle 10 and/or the charging station.

Step 134: End/Loop.

After either step 130 or step 132, the method 100 ends. In many configurations, the method 100 will loop constantly, or at a regular interval, while the charging cycle is operational.

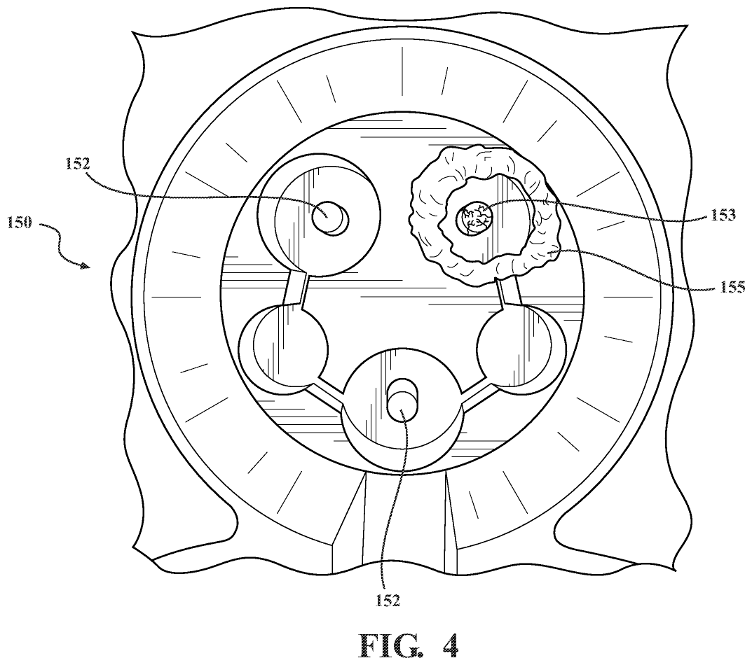

Referring now to FIG. 4, and with reference to all other figures, there is shown a charging receptacle 150, which illustrates some possible damage to charging receptacles, as described herein. Skilled artisans will recognize that the charging receptacle 150 is similar to all, or portions of, the charging receptacle 30 shown in FIG. 1.

The charging receptacle 150 includes a plurality of pins 152, which are substantially in undamaged, or working, condition. However, the charging receptacle 150 also includes a damaged pin 153. The damaged pin 153 may have been cracked by an improperly aligned charging cable or plug mating with the charging receptacle 150. Furthermore, the damaged pin 153 may have caused electric arcing, such that the housing of the charging receptacle 150 around the damaged pin 153 has been melted.

Additional methods for health assessment of charging receptacles, such as the charging receptacle 150 or the charging receptacle 30 may include image analysis of the respective charging receptacle. For example, and without limitation, the operator of the vehicle may be prompted to take a picture, photograph, or image of the charging receptacle 150 at periodic intervals or may take the photograph whenever the operator is so inclined. The photograph, or simply photo, may be taken with a smart phone or other smart device having a camera associated therewith, and may be referred to as a current photo, as opposed to a previous or historical photo.

Thereafter, the photograph is sent, for example and without limitation, to a cloud network for image processing. The cloud network may utilize any number of techniques to review the current photo, including, without limitation: human review, image identification, computer vision, machine learning, or artificial intelligence, to identify possible damage or faults to the charging receptacle 30. In general, any and all techniques to review the current photo, and/or all previous and historic photos, will be referred to as, simply, image processing. Note that the vehicle 10 may also be included in the image processing and, also, that there may be a hybrid approach where both the cloud network and the vehicle 10 participate in the image processing.

The cloud network, the dedicated app, or both, may have a database of historical or previous photos of the charging receptacle 30. From these previous photos, a baseline charging port health may be determined. For example, and without limitation, the baseline charging port health may be created by melding the previous photos together to determine an expected status for the charging receptacle 30. Additionally, the image processing techniques may account for the accumulation of dirt and debris on the charging receptacle 30. Therefore, identification of faults may occur by comparing the current photo to the baseline charging port health.

If the cloud network, or similarly equipped systems, determines that there is likely damage on the charging receptacle 30, a maintenance alert may be signaled or sent. The maintenance alert may include, for example and without limitation: signaling the operator of the vehicle, such as through an onboard light, a messaging system, or a smart device app; notifying a manager of the fleet, if the vehicle 10 is part of a fleet; or alerting service personnel or repair personnel.

The smart phone or smart device camera may utilize an app or upload images for analysis through the internet. In some situations, a dedicated app for the electrified vehicle 10 may be used to import one or more photos. Additionally, the dedicated app may be used to remind the operator, such as the driver of the vehicle 10, to take photos for assessment of the charging receptacle 30, or the dedicated app may allow the operator to take a photo whenever the operator prefers to do so. The dedicated app may be configured to send notifications through the smart device. Possible damage that may be detectable includes, without limitation, burn marks caused by electric arcs, grindings, cracks, melted portions, or other faults in the pins 32, in addition to melted portions or cracks on the housing of the charging receptacle 30.

In some configurations, the methods and mechanisms for assessing health of the charging port may simply determine a number of potential faults from the image analysis. Therefore, the identified or estimated number of faults may be compared to a predetermined threshold and, if too many faults are identified, may either prevent charging of the electrified vehicle 10 or may limit charging to short period of time. For example, and without limitation, the controller 14 may limit the charging cycle or charging event to an amount that will allow the operator of the vehicle 10 to get to a repair or maintenance facility or to the operator's home.

In other configurations, the cloud network may determine or calculate a fault severity index based on the type, number, and severity of the faults identified during image processing of the current photo. Skilled artisans will recognize mechanisms for calculating the fault severity index, including, without limitation, applying numeric values or grading the identified faults and adding up the values or grades. After calculation, the fault severity index may be compared to a threshold index level and, if the fault severity index exceeds the threshold index level, either preventing the charging event, by disabling charging, or limiting the charging event, such as described above. Alternatively, the systems may adjust system parameters to account for any identified faults.

Referring also to FIG. 5, and with reference to all other figures, there is shown a cordset 210, which illustrates some possible damage to the cordset 210, or other cordsets, that may be attached to charging receptacles, such as the charging receptacle 150 of FIG. 4 or the charging receptacle 30 of FIG. 1. The cordset 210 includes a cord 212 bringing power from a charging station (not separately shown) to a plug 214.

The cordset 210 includes a plurality of socket elements 216 as part of the plug 214, which may cooperate with, for example, the pins 32. Additionally, the cordset 210 has a plug lock 220 on the plug 214, which may cooperate with the lock 40 of the charging receptacle 30 in order to latch the cordset 210 to the charging receptacle 30. In some configurations of the electrified vehicle 10, the plug lock 220 and the lock 40 must properly latch before the charging process or charging cycle will commence.

The cordset 210 may also be subject to image processing techniques, similar to those used relative to the charging receptacle 30. For example, and without limitation, the operator may take a picture of the cordset 210, and the app may use image processing techniques to determine whether the cordset 210, or portions thereof, has signs damage. Thereafter, the app may determine—for example, and without limitation, through the cloud network—whether the damage is significant enough to prevent the charging event or to limit the charging event. The plug 214 may also have a baseline plug health created via the previous photos, similar to the baseline charging port health of the charging receptacle 30.

In situations where the electrified vehicle 10 includes a dedicated app, or a linked app, such an app may provide additional features. For example, and without limitation, when the operator takes a picture of the plug 214, the app may be configured to discern whether the plug 214—or, more generally, the cordset 210—is compatible with the charging receptacle 30 of the vehicle 10.

Via image processing and feature analysis, the dedicated app may be able to determine whether the socket elements 216 of the respective plug 214 line up with the pins 32 and/or is capable of charging the RESS 12. This may be part of the determination of geometric matching/mismatching between the socket element 216 and the pins 32. Geometric mismatch may refer to, without limitation, the following situations: the cordset 210 is not compatible with the charging receptacle 30, or one of the cordset 210 and the charging receptacle 30 has been damaged, such that the pins 32 no longer properly align with the socket elements 216.

Note that many different types of cordsets exist for different types of charging stations. Some, but not all, may be compatible with the charging componentry of the electrified vehicle 10. Furthermore, otherwise non-compatible cordsets may be able to cooperate with the charging componentry of the electrified vehicle 10 with an adaptor (not shown) between the charging station and the charging receptacle 30. The dedicated app may also be configured to, via image processing, determine whether the cordset 210 is compatible with the charging receptacle 30 of the electrified vehicle 10.

In some instances, the app may report that the cordset 210 is compatible but requires an adapter (not shown) to be compatible with the charging receptacle 30. Many different adaptors may be used by the operator to mate the specific cordset 210 to the specific charging receptacle 30.

As shown in FIG. 1, the vehicle 10 includes the coolant circuit 20. In addition to performing health assessment on the charging receptacle 30, itself, the vehicle 10 may be configured to perform health assessments of the coolant circuit 20. The flow chart of FIG. 3 represents a similar algorithm or method for assessing the coolant circuit 20.

The process of assessing the coolant circuit 20 includes monitoring temperature similar to the method 100 shown in FIG. 3. However, at step 120, instead of applying a step to the charging current, the controller 14 holds the charging current steady while applying a step to the liquid coolant flow through the coolant circuit 20 and monitors the temperature change during said coolant step.

The coolant step may be applied as an increase or decrease. For example, if the coolant flow increases through the coolant circuit 20, it would be expected that the temperature of the pins 32 in the charging receptacle 30 will decrease. However, if the coolant circuit 20 is not operating properly, the temperature decrease may not be fully realized.

A deviation may be calculated from the difference between the measured temperature and the expected temperature of the pins 32. From that deviation, the controller 14 can compare against thresholds to assess the health of the coolant circuit 20, in a similar manner to the methods shown in FIG. 3.

As shown in FIG. 1, the charging receptacle 30 includes the lock 40, which interacts with a corresponding locking mechanism on the charging cordset 210, such as the plug lock 220 shown in FIG. 5. However, the lock 40 of the charging cable lock may become damaged or not work properly. Therefore, it may be beneficial to have a health assessment of the lock 40 and/or charging cable lock.

In many interactions or charging events, the lock 40 and the plug lock 220 must successfully latch to one another before the charging cycle may begin or initiate. Therefore, the controller 14 knows whether the lock 40 and the plug lock 220, or another locking mechanism of the cordset 210, have successfully engaged. As such, health assessments may be performed on the lock 40, the plug lock 220, or both.

As the cordset 210 is brought to the charging receptacle 30, the two are placed or pushed together, preferably with the socket elements 216 generally aligning with one or more of the pins 32. This process may be referred to as mating the cordset 210 to the charging receptacle 30, and includes attempts that are unsuccessful and latching between the lock 40 and the plug lock 220.

Successful latching refers to situations in which the controller 14 determines that it is properly communicating with the charging station and that the charging event may proceed. Therefore, the methods assess latching performance, which can include one or more of counting the number of latching attempts, monitoring the latching time, or assessing contact quality, such as through resistance measurement. Note the references to counting the number of latching attempts may incorporate other mechanisms for assessing latching performance.

For example, and without limitation, if the lock 40 on the charging receptacle 30 normally latches successfully on the first or second try, but at a specific charging station it takes five attempts to latch to that specific plug lock 220, that suggests that the charging cable lock may be damaged or otherwise not working properly. The normal, or expected, total number of latching attempts for the charging receptacle 30 may be used to set an expected receptacle baseline. Skilled artisans will recognize mechanisms for determining the expected baseline levels, based on historical latching attempts for the charging receptacle 30, the cordset 210, or both.

The controller 14 may then use a communications network to flag the charging station by sending a maintenance reminder through the cloud network for that specific cordset 210 of the charging station. The maintenance reminder alerts that the charging station may need inspection and/or repair, which may occur through personnel unrelated to the operator of the electrified vehicle 10.

Similarly, and without limitation, if the lock 40 has difficulty latching successfully to the plug lock 220 of a charging station that normally latches on the first or second try, the controller 14 or the cloud network may determine that the lock 40 is not working properly, and may flag the charging receptacle 30 of the electrified vehicle 10 through the cloud network. This may include sending a maintenance reminder through the cloud network for inspection and/or repair of the lock 40. Note that where the vehicle 10 includes the dedicated app, the maintenance reminder may be sent through the app. Additionally, the app, via the cloud network, may automatically schedule maintenance at an approved service provider.

This disclosure overcomes several problems in the technical field, including, without limitation: preventing a loss of propulsion or inability to charge of the vehicle; fault isolation between vehicle and charge infrastructure; or reducing towing and alternative transportation cost, as well as labor cost associated with fault isolation. The disclosed embodiments effectuate an improvement in the technical field by, for example, and without limitation: identifying faults via photos and sending maintenance messages to resolve the faults; determining whether the number of latch attempts exceeds the expected baseline for the cordset or the charging receptacle and alerting, such as through a cloud network; or preventing/limiting charging based on adjusted system parameters due to identified faults.

The detailed description and the drawings or figures are supportive and descriptive of the subject matter herein. While some of the best modes and other embodiments have been described in detail, various alternative designs, embodiments, and configurations exist.

Furthermore, any embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A method for assessing health of a charging port in an electrified vehicle, comprising:
taking a current photo of one of a charging receptacle or a cordset of the charging port;
image processing the current photo;
determining whether the current photo includes one or more identified faults from the image processed current photo; and
if one or more identified faults are present, sending a maintenance message.

2. The method of claim 1, wherein image processing the current photo occurs in a cloud network, remote from the electrified vehicle.

3. The method of claim 2, wherein the identified faults include at least one of cracked pins, melted pins, melted housing, or cracked housing of the charging receptacle.

4. The method of claim 3, further comprising:
creating a severity index based on the identified faults;
comparing the severity index to a threshold index level; and
if the severity index exceeds the threshold index level, one of preventing a charging event or limiting the charging event.

5. The method of claim 3, further comprising:
calculating a total number of identified faults; and
comparing the total number of identified faults to a predetermined threshold, if the total number of identified faults is greater than the predetermined threshold, one of preventing a charging event or limiting the charging event.

6. The method of claim 1, further comprising:
comparing the current photo to a historic photo from the electrified vehicle; and
determining whether the current photo includes identified faults from the comparison between the current photo and the historic photo.

7. The method of claim 2, wherein the cloud network includes a plurality of previous photos and, further comprising:
establishing a baseline charging port health based on the previous photos.

8. The method of claim 7, further comprising:
comparing the current photo to the baseline charging port health to determine whether the current photo includes the identified faults.

9. The method of claim 2, further comprising:
taking the current photo with a smart device app, wherein an operator of the electrified vehicle takes the current photo with the smart device app.

10. The method of claim 9, further comprising:
reminding the operator to take the current photo via a notification from the smart device app.

11. The method of claim 10, further comprising:
taking the current photo of the cordset;
inputting the current photo of the cordset into the smart device app; and
determining whether the cordset is compatible with the charging receptacle via the smart device app.

12. A method for assessing health of a charging port in an electrified vehicle, comprising:
mating a cordset of a charging station to a charging receptacle of the electrified vehicle;
counting a number of latch attempts to successfully latch the cordset to the charging receptacle;
comparing the number of latch attempts to an expected receptacle baseline for the charging receptacle; and
if the number of latch attempts exceeds the expected receptacle baseline, flagging the cordset of the charging station through a cloud network.

13. The method of claim 12, further comprising:
comparing the number of latch attempts to an expected cordset baseline for the cordset for the charging receptacle; and
if the number of latch attempts exceeds the expected cordset baseline, flagging the charging receptacle of the electrified vehicle through the cloud network.

14. The method of claim 13, wherein flagging the cordset of the charging station or flagging the charging receptacle of the electrified vehicle, further includes at least one of:
sending a maintenance reminder through the cloud network for the cordset of the charging station, or
sending a maintenance reminder through the cloud network for the charging receptacle of the electrified vehicle.

15. A non-transitory computer-readable medium including contents that are configured to cause a computing system to perform a method related to a charging port of an electrified vehicle, the method comprising:
taking a current photo of one of a charging receptacle or a cordset of the charging port;
image processing the current photo;
determining whether the current photo includes one or more identified faults from the image processed current photo; and
if one or more identified faults are present, sending a maintenance message.

16. The non-transitory computer-readable medium of claim 15, wherein image processing the current photo occurs in a cloud network, remote from the electrified vehicle.

17. The non-transitory computer-readable medium of claim 16, further comprising:
creating a severity index based on the identified faults;
comparing the severity index to a threshold index level; and
if the severity index exceeds the threshold index level, one of preventing a charging event or limiting the charging event.

18. The non-transitory computer-readable medium of claim 17, wherein the cloud network includes a plurality of previous photos and, further comprising:
establishing a baseline charging port health based on the previous photos.

19. The non-transitory computer-readable medium of claim 15, when one or more identified faults are present, further comprising:
disabling charging; or
adjusting system parameters to limit charging.

20. The non-transitory computer-readable medium of claim 15, further comprising:
comparing the current photo to one or more previous photos of the electrified vehicle; and
determining whether the current photo includes identified faults from the comparison between the current photo and the one or more of the previous photos.
